(19) United States
(12) Patent Application Publication
(10) Pub. No.: US 2009/0210508 A1
(43) Pub. Date: Aug. 20, 2009

(54) METHODS AND SYSTEMS FOR PROVIDING INFORMATION ASSOCIATED WITH A CONSUMER GOOD

(75) Inventor: FRANCESCO TONI, Gatteo a Mare (Forli) (IT)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Tommy S.r.l, Cesena (IT)

(21) Appl. No.: 12/032,051

(22) Filed: Feb. 15, 2008

(51) Int. Cl. G06F 15/16

(52) U.S. Cl. 709/207

(57) ABSTRACT

Methods and systems are disclosed for providing information associated with a consumer good and stored in a database. According to one such method, a descriptor of the consumer good is received, information associated with the descriptor is extracted from the database, and the extracted information is transmitted. In the receiving, an SMS or MMS request message including the descriptor is processed. In the transmitting, an SMS or MMS response message including the extracted information is sent.

### FIELD OF THE INVENTION

The present invention relates to methods and systems for providing information, and more particularly to methods and systems for providing information associated with a consumer good and stored in a database.

### BACKGROUND OF THE INVENTION

In a known method for providing information associated with a consumer good, a user interested in the consumer good requests one or more pieces of information from an information provider, and the provider selects the information in a database and transmits it as a response to the user. The most recent of such methods for providing information foresee an almost automatic response by the provider.

According to these methods of providing information, the user connects to a web page of the provider and selects the consumer good of interest, as well as the desired information to be retrieved. A database management system receives the request of the user, selects the requested information, and, if available, transmits this information, always as a web page, to the user.

These methods for providing information are advantageous, since the user is almost free from hassles such as calling an operator. Moreover, the answer by the provider is automated.

Nevertheless, these methods for providing information have serious drawbacks, since the information request is not associated with a specific consumer good available in the marketplace.

In other words, these methods do not provide information relating to a commercially available consumer good, but only generic information associated with a model of the consumer good.

As an example, consider the following case of providing information.

A user identifies a clock in a shop window and wants information about that clock. According to the known method, the user transmits a request to the database management system, for instance a request that includes the make and model of the clock.

The user request is received, and a plurality of information of interest to the user is extracted from the database and transmitted back to the user, for instance information specifying the price of the clock.

Nevertheless, this method for providing information does not provide information associated with the specific clock which is identified by the user in the shop window, for instance its authenticity and provenance.

These methods for providing information also have other limitations due to the fact that the user has to be connected to the provider's web page in order to request information. As is known, the majority of users connected to the Internet use a personal computer which is in a fixed position; therefore, for such users this method for providing information is not accessible when they are looking at the real consumer good.

Moreover it is known that a minority of users are connected to the Internet through portable electronic devices, such as handheld computers and smart phones.

Nevertheless, although these handheld electronic devices allow the use of the method for providing information when looking at the consumer good, it is far from practical to connect to the webpage of the provider and send the information request using the portable electronic device, which generally has a small screen and is difficult to navigate. Moreover, the webpage downloaded to the portable electronic device often includes undesired information, like images or advertising banners which are unrelated to the requested information.

### SUMMARY OF THE INVENTION

It is an object of the present invention to overcome the above-mentioned problems and to provide a method and system for providing information associated with a consumer good which facilitates the retrieving of associated information, not only of a generic consumer good but also of a specific commercially available specimen of such consumer good, in a generally automated way and without the need to contact an operator or employee of the provider.

In general, in preferred embodiments of the present invention an information request related to a consumer good is received via a text message which is sent from a user mobile phone to a database management system, and the information associated with the good is transmitted via a text message sent by the management system to the user mobile phone.

One embodiment of the present invention provides a method for providing information associated with a consumer good and stored in a database. According to the method, a descriptor of the consumer good is received, information associated with the descriptor is extracted from the database, and the extracted information is transmitted. The receiving step includes the processing of an SMS or MMS request message comprising the descriptor, and the transmitting step comprises the transmission of an SMS or MMS response message comprising the extracted information.

Advantageously, because the request is sent via a simple text message in the SMS or MMS format, it can be sent from a cellular phone without any connection to the Internet.

In some embodiments, the information is requested by identifying a specific consumer good (i.e., a commercially available specimen of the good) by inserting an identification code into the descriptor, and specific information on the specimen is received, such as information regarding its authenticity or provenance.

Advantageously, sending the request message in the SMS or MMS format is very simple and allows anyone with a mobile phone to use the method.

Moreover, in some embodiments sending the SMS or MMS messages from the database management system to a user is automated according to predetermined time intervals. The automated sending at predetermined time intervals allows the user to always be updated with respect to a relevant consumer good.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 shows a block diagram of an information transmission method according to one embodiment of the present invention,

FIG. 2 shows the steps of identifying a user and sending information according to one embodiment of the present invention, and

FIG. 3 shows a system for providing information according to one embodiment of the present invention.

### DETAILED DESCRIPTION OF PREFERRED EMBODIMENTS

The attached figures show a method and system for providing information associated with a consumer good and stored in a database of an information provider according to one embodiment of the present invention.

The database is managed by a management system which stores a plurality of information associated with the consumer good. For instance, the database contains information regarding a piece of clothing, including its model, brand, color, size, fabric, address and name of at least one reseller of the clothing, an identification code for the clothing, and an original marking.

The database management system receives a descriptor of a consumer good from a user who is interested in this consumer good, extracts information associated with the descriptor from the database, and transmits such extracted information to the requesting user.

According to this embodiment of the present invention, the receiving step comprises processing of an SMS/MMS message request which is sent by the user to the database management system and which comprises the descriptor for the consumer good. The descriptor is sent by a cellular phone, of a conventional type, in a textual form and according to a predetermined syntax.

The transmission step according to this embodiment of the present invention comprises sending an SMS/MMS response message from the management system to the user's cellular phone, with the response message comprising the information extracted from the database.

Advantageously, sending the SMS/MMS request message and receiving the SMS/MMS response message do not require an Internet connection, but simply writing a text SMS/MMS request message and visualizing the SMS/MMS response message. Advantageously, writing the SMS/MMS request message is very simple even with a cellular phone having a small screen, and visualizing the information transmitted by the management system is also simple since the SMS/MMS response message is also a text message.

In this embodiment, the descriptor comprises a plurality of descriptive parameters of the consumer good, for instance the brand of the consumer good.

In one simple embodiment of the present invention, the descriptor includes only one request parameter and the SMS/MMS response message includes only one piece of information. For instance, the descriptor specifies the brand of a clock and the SMS/MMS response message contains the clock's price.

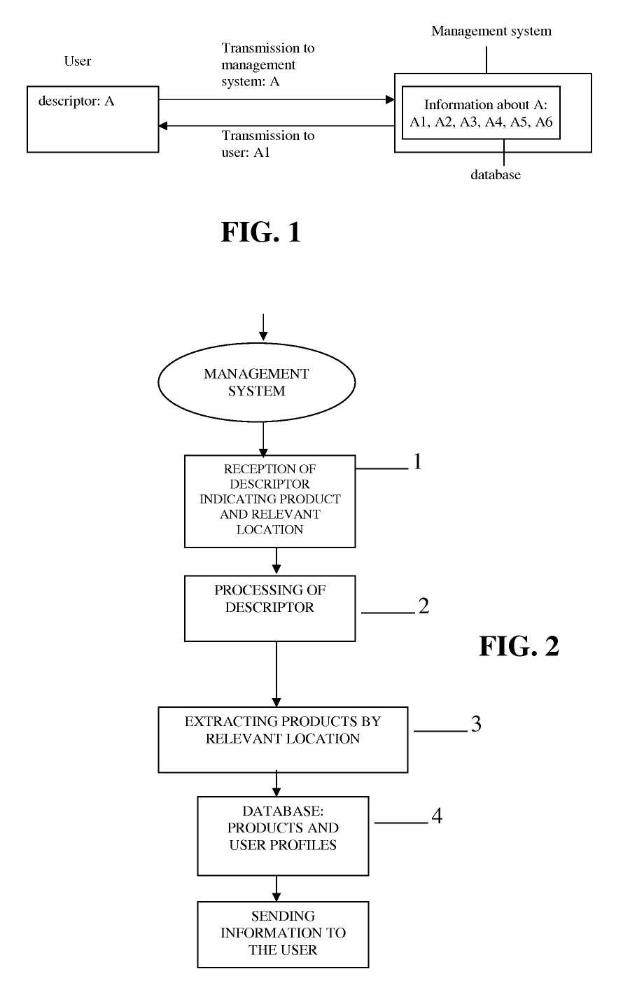

FIG. 1 shows this simple embodiment. A user sends to the management system an SMS/MMS request message comprising descriptor A, for instance the first letter A of a known sneaker brand. The management system receives the SMS/MMS request message with descriptor A, extracts from database information A1 associated with descriptor A (for instance, the price), and transmits the information A1 to the user. In this example, the management system, upon receiving a descriptor containing only one request parameter A, sends an SMS/MMS response message containing only information A1.

Alternatively, the descriptor may comprise two or more request parameters and the SMS/MMS response message may comprises two or more pieces of information.

For example, in order to request information about a consumer good of a brand associated with more than one model, it is envisaged that the descriptor, besides the brand, also includes the model name or an initial of the model name.

Moreover, in order to identify a geographical area of interest, in which the consumer good is distributed and commercially available, the request parameters of some embodiments include a geographical location of interest. The management system extracts from the database only the information about the consumer good distributed in the geographical location of interest and transmits the SMS response message. For example, the extracted information can comprise a list of shops which sell the consumer good in that particular geographical location, at which it is possible to acquire the consumer good.

In a further embodiment, in order to request information about the authenticity of a consumer good, a unique good identifier, for example a numerical or bar code, is inserted in the descriptor and sent to the management system via the SMS/MMS request message.

The management system accesses the database using as an information selection key the unique code, extracts information identifying the product authenticity, and transmits the identification information in the SMS/MMS request message.

Advantageously, the user is therefore able to verify the authenticity of a consumer good, so as to avoid the purchase of counterfeit products.

The SMS/MMS message responding to such an authentication request may also comprise a plurality of information referring to the consumer good associated with the unique code, for instance its origin.

FIG. 2 shows a block diagram of a method for providing information about the geographical location of consumer goods according to one embodiment of the present invention.

In block 1, the management system receives a descriptor indicating the consumer good and the geographical location of interest of the good. In block 2, the management system extracts the request parameters of the descriptor identifying the consumer good, for instance an initial or a code, and the geographical location of interest.

The management system generates a selection query from the database and extracts the information associated with the consumer good, as shown in blocks 3 and 4. Finally, in block 5, the management system sends the information to the user which sent the request.

The descriptor is preferably structured according to a specific format and a syntax as described below, so as to allow the management system to process the descriptor and obtain a selection formula or query for the database. Such selection formula is used for the extraction step.

The method preferably also includes signaling the user when information on a consumer good is not available. In particular, if for a given descriptor the extraction step does not extract any information, the management system sends an SMS/MMS “failure” message.

The “failure” message specifies whether the lack of information regarding a good is due to the consumer good not being registered in the database or a wrong syntax of the descriptor.

Moreover, the method preferably also includes the transmission of SMS/MMS response messages not only after reception of an SMS/MMS request message but also at predetermined intervals. Such SMS/MMS response messages include, for example, available commercial offers for the consumer good.

In particular, sending SMS/MMS response messages at predetermined intervals occurs when the user accepts an offer for a subscription to an information provider, for instance promotional information of the above type or advertising. The user accepts the subscription proposal by sending an SMS/MMS request message, in a predetermined format. In the case of a subscription, a user's contact phone number is stored in the database and is linked to the consumer good.

Advantageously, storing the contact information allows storing only information of interest to the user regarding the consumer good.

In the case of a subscription, the SMS/MMS response message is therefore sent not only following the reception of an SMS/MMS request message but also at predefined time intervals.

Preferably, the information associated with the consumer goods is updated. In particular, the database control system is connected to a network through which the reseller of the consumer good updates the information relative to its goods, for instance erasing from the database a good which has been sold or inserting a promotional offer or inserting information regarding consumer goods as soon as they are put on show.

In one embodiment of present invention, the management system stores all SMS/MMS request messages, all SMS/MMS response messages, and all phone contacts of users who have requested information. The phone numbers are used only in the case of a subscription, whereas stored SMS/MMS request and response messages are used for generating statistics about, for example, the most requested consumer goods, information regarding the most requested consumer goods, and geographic locations where a consumer good is more requested.

In another embodiment of the present invention, the request message sent by the user to the database management system is in an html format. The descriptor is sent through an electronic device, of the conventional type, and includes text according to a predefined syntax. In this case, the transmission step comprises sending an html response message from the management system to the user's electronic device, with the response message comprising information extracted from the database.

The following description of a specific exemplary embodiment of the present invention is provided only for illustrative purposes.

A user interested in a particular consumer good, for example a piece of clothing, sends an SMS or MMS request message to a predefined telephone number corresponding to a database management system. The message includes a descriptor containing, for example, the name, model, size, and brand of the piece of clothing.

The management system stores the descriptor in the database, in order to generate statistics regarding information requests for consumer goods. The management system also stores the phone number or other data associated with the requesting user, in order to send, in the case of subscription to a subscription service, at predetermined time intervals, information about the clothing of the requested brand.

The descriptor is processed by the management system and is transformed into a selection query that is used for extracting relevant information from the database.

If the selection query yields one or more pieces of information about the requested clothing, the management system transmits the information inside an SMS or MMS response message, and stores the message in the database, for statistical use, for example in order to determine the most requested consumer goods.

On the other hand, if the selection query does not yield any result, the management system transmits an SMS or MMS message indicating that no information is present regarding the requested clothing or that the request message syntax is incorrect.

Based on stored statistical information, the manufacturer or reseller of a consumer good may ask the management system to execute an extraction query on the requested information regarding the consumer goods.

In order to better understand the principles of the present invention, some of its possible embodiments are hereinafter described, in an illustrative and non-limiting way.

In a first example, a user interested in an article, for instance a clock, sends a message to a phone number corresponding to the management system. The user message comprises the brand and model of the article and the area of interest (where the user wants to take a look at the article or purchase the same). The management system receives and processes the user request and sends an SMS or MMS or HTML or video message comprising a list of shops, inside the area of interest, where it is possible to acquire the article. The management system may also send a specific offer for the requested article and/or further information provided by the manufacturer, such as related products and accessories for the clock and/or a subscription proposal for a newsletter, in order to receive information regarding the article on a regular basis.

In a second example, a user interested in acquiring clothing sends a message comprising brand, model, area, color, and size of the clothing. The management system receives and processes the user request and sends a response message comprising a list of shops where it is possible to purchase the clothing. Moreover, the management system may insert a special offer or discount for the clothing into the response message, and/or further information and/or an advertising message, and/or a newsletter subscription proposal.

In a third example, a user interested in a specific article under scrutiny sends a message comprising a numerical code corresponding to a bar code for that article. In this case, the management system, after receiving and processing the user request, responds an SMS, MMS, HTML, or video-message to the user comprising the product's name, its origin, the manufacturer and/or distributor and/or the brand owner. Moreover, the management system may insert information related to the product under scrutiny, and/or promotional information and/or information describing the availability of the product, for instance its availability in real time. The quantity of information received by the user depends on the level of detail of data inserted by the manufacturer and/or distributor and/or brand owner into the database of the management system. In particular, the greater the amount of information, the better the service to the end user.

In a fourth example, a user sends a message in order to verify the authenticity of an article under scrutiny; the message comprises a numerical code corresponding to a bar code for the product, or a similar security code, and a code that tells that the user request is related to authenticity verification of the article. A code for identifying an authenticity verification request comprises, for example, a predetermined character string, for instance the word “original”.

In this case, the management system, receives and processes the user request, identifying the authenticity verification request, and sends a response message comprising the brand and/or model of the article to the user. This information may be used by the user for verifying the analyzed product. Moreover, the management system may insert further anti-counterfeit measures into the message, for example by specifying that the article under scrutiny should bear a specific inscription in a predetermined position (e.g., for a Cartier watch, the name “Cartier” should be positioned at the Roman numeral V of the watch quadrant). Finally, the management system may insert further information into the response message, such as the precise geographical position of the article and its origin.

A user having a cellular phone and a barcode reader may send a request message, for example in order to verify the authenticity of the product, without having to manually input the barcode.

In the following there is described a simple exemplary embodiment of the present invention in which the management system sends a message to a user who has subscribed to a service for providing information.

For example, a company wanting to promote a new product or a new line of products asks the management system to send information about the products to the users which have signed up for the subscription.

In this case, the management system sends to a specific list of subscribers an SMS, MMS, HTML, or video message comprising an offer and/or advertising information regarding the new product. Advantageously, the information sent by the management system is sent to subscribed users, and therefore only to interested users.

In the following, an embodiment of the present invention is described which is particularly useful for a company which wants to assess the performance of a traditional advertising campaign, for example by radio, TV, or in print.

According to this exemplary embodiment, a predetermined code or promotional code is rendered visible during a traditional advertising campaign for a certain product, for example on television or on a clearly visible advertising sign.

A user interested in the product, by identifying the promotional code during the advertising spot or on the poster, inserts the promotional code into a message, for example an SMS message on a mobile phone, and sends it to the management system.

The management system, based on the number of promotional messages received from users, evaluates the efficiency of the traditional advertising campaign.

Advantageously, this evaluation does not depend on data provided by the medium of the traditional advertising campaign, for example the “auditel” data provided by the television station.

The present invention also provides systems for managing information associated with a consumer good. The system of one embodiment includes a database management system which stores the information and includes means for receiving a descriptor of a consumer good, extracting information associated with the descriptor from the database, and transmitting the extracted information.

According to this embodiment of the present invention, the descriptor is inserted in an SMS/MMS request message which is sent via an electronic device, such as a cellular phone, from a user requesting information regarding the consumer good to the management system. For example, the user's electronic device and the management system can be interconnected through an SMS/MMS message transmission network, for instance a GSM network. Alternatively, the user's electronic device may be connected with the management system through a different telecommunications network or the request message may, for example, be sent in an html format or as a video message.

In this embodiment, the extracted information is inserted into an SMS/MMS response message, which is sent by the management system to the user's electronic device. Also in this case the request message may be transmitted from the management system to the user's device as html code or as a video message.

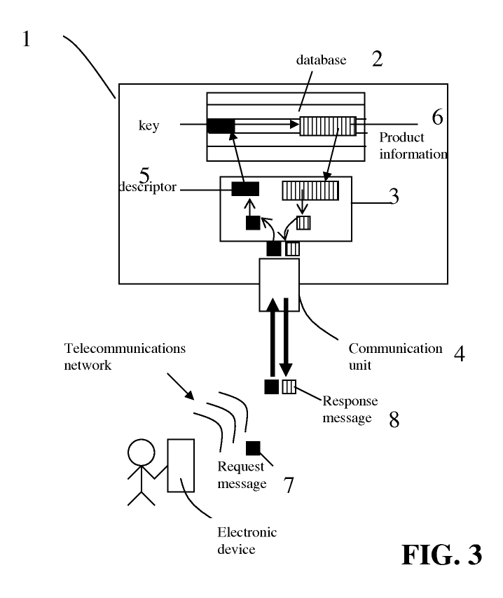

FIG. 3 shows a system for providing information according to one embodiment of the present invention. As shown, the system 1 for providing information includes a database 2 for storing information, a management system 3 for the database 2, and a communication unit 4 for receiving descriptors 5 of consumer goods and for transmitting information 6 extracted from the database 2.

The information 6 is extracted by the management system 3 which carries out an extraction query on the database 2 using a descriptor 5 of the consumer good as the extraction key. The descriptor 5 is encapsulated in an SMS/MMS request message 7, and the extracted information 6 is encapsulated in an SMS/MMS response message 8, respectively received and sent by the communication unit 2.

As shown in FIG. 3, the communication unit 2 of system 1 receives a request message formed by an SMS/MMS request message 7 and transmits it to the management system 3. The management system 3 extracts the descriptor 5 from the SMS/MMS message, and uses it as an extraction key for information in the database 2. The extracted information 6 is encapsulated in an SMS/MMS response message, which is forwarded by the management system 2 to the communication unit 4.

Advantageously, methods and systems for providing information according to the present invention provide fast and simple diffusion of information regarding consumer goods.

In fact, the manufacturer or reseller of a consumer good may publish the descriptor concerning its own goods, for example on an advertising banner at a shop window, or through a radio or television information broadcast, or by email. The user, by inputting the descriptor as an SMS/MMS message on its own cellular phone and by sending the message to the phone number of the management system, readily obtains precise information, as a textual SMS/MMS message.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for providing information associated with a consumer good and stored in a database, the method comprising the steps of:
receiving a descriptor of the consumer good;
extracting information associated with the descriptor from the database; and
transmitting the information that is extracted,
wherein the receiving step comprises processing an SMS or MMS request message comprising the descriptor, and
the transmitting step comprises sending an SMS or MMS response message comprising the information that is extracted.

2. The method according to claim 1, wherein the descriptor comprises a brand of the consumer good.

3. The method according to claim 2, wherein the descriptor further comprises a model of the consumer good.

4. The method according to claim 2, wherein the descriptor further comprises a geographical location of interest.

5. The method according to claim 4, wherein the SMS or MMS response message includes a list of resellers of the consumer good in the geographical location of interest.

6. The method according to claim 1, wherein the descriptor comprises a unique identifier of the consumer good.

7. The method according to claim 6, wherein the unique identifier is a bar code.

8. The method according to claim 6, wherein the SMS or MMS response message includes at least one of a provenance and authenticity information for the consumer good.

9. The method according to claim 1, wherein the transmitting step comprises sending a “failure” message if the database does not contain information associated with the descriptor.

10. The method according to claim 1, wherein the SMS or MMS response message includes a commercial offer available for the consumer good.

11. The method according to claim 1, wherein the SMS or MMS response message includes a proposal for receiving information from a subscription based service.

12. The method according to claim 11, wherein the SMS or MMS request message includes a confirmation of subscription to the subscription based service.

13. The method according to claim 12, wherein the transmitting step further comprises sending additional SMS or MMS response messages at predetermined time intervals after receiving the confirmation of subscription.

14. The method according to claim 1, further comprising the step of updating the information associated with the consumer good.

15. The method according to claim 1, further comprising the step of recording the descriptor that is received.

16. The method according to claim 15, wherein the recording step comprises storing the SMS or MMS response message sent in the transmitting step.

17. The method according to claim 1, wherein the request message is an html message.

18. A system for providing information associated with a consumer good, the system comprising:
a database for storing the information;
a management system for the database; and
a communication unit for receiving a descriptor of the consumer good and transmitting information extracted from the database,
wherein the management system extracts the information extracted from the database based on the descriptor,
the descriptor is encapsulated in an SMS or MMS request message received by the communication unit, and
the extracted information is encapsulated in an SMS or MMS response message sent by the communication unit.

19. A tangible computer readable medium encoded with a computer program for providing information associated with a consumer good and stored in a database, the computer program comprising instructions for:
receiving a descriptor of the consumer good;
extracting information associated with the descriptor from the database; and
transmitting the information that is extracted,
wherein the receiving step comprises processing an SMS or MMS request message comprising the descriptor, and
the transmitting step comprises sending an SMS or MMS response message comprising the information that is extracted.

20. The tangible computer readable medium according to claim 19, wherein the descriptor comprises a unique identifier of the consumer good.
